(19) United States
(12) Patent Application Publication
(10) Pub. No.: US 2024/0013123 A1
(43) Pub. Date: Jan. 11, 2024

(54) UTILIZING MACHINE LEARNING MODELS TO ANALYZE AN IMPACT OF A CHANGE REQUEST

(71) Applicant: Accenture Global Solutions Limited, Dublin (IE)

(72) Inventors: Pritha LATHA, Bangalore (IN); Aditi KULKARNI, Bangalore (IN); Koushik M. VIJAYARAGHAVAN, Chennai (IN); Rajesh NAGARAJAN, Chennai (IN); Gaurav SOOD, Mohali (IN); Sujan KUMAR SAHA, 24 Parganas North (IN); Aparna Samir JOSHI, Thane West (IN)

(21) Appl. No.: 17/859,168

(22) Filed: Jul. 7, 2022

(51) Int. Cl. G06Q 10/06; G06Q 10/10

(52) U.S. Cl. CPC G06Q 10/06375; G06Q 10/06313; G06Q 10/103

(57) ABSTRACT

A device may receive and process a change request, work items, and IT data, to generate processed data. The device may transform the processed data into vectorized data, and may select similarity analytics models, regression models, and a classification model. The device may process the vectorized data, with the similarity analytics models, to determine an estimated effort, a user story, and IT requirements, and may process the vectorized data, with the regression models, to determine a schedule overrun, a defect rate, and a sprint velocity. The device may process the vectorized data, with the classification model, to determine a story point, and may calculate a resource capacity. The device may generate an impact analysis based on the estimated effort, the user story, the IT requirements, the schedule overrun, the defect rate, the sprint velocity, the story point, or the resource capacity, and may perform actions based on the impact analysis.

### BACKGROUND

Businesses currently operate in a dynamic environment driven by changing market and project requirements, and rapidly evolving technology. On-time delivery of a product and/or a service is key to management of swiftly changing work dynamics.

### SUMMARY

Some implementations described herein relate to a method. The method may include receiving a change request, work items associated with the change request, and information technology (IT) data identifying IT deliverables, and processing the change request, the work items, and the IT data to generate processed data. The method may include transforming the processed data into vectorized data, and selecting similarity analytics machine learning models, regression machine learning models, and a classification machine learning model based on the vectorized data. The method may include processing the vectorized data, with the similarity analytics machine learning models, to determine an estimated effort, a user story, and IT requirements for the change request, and processing the vectorized data, with the regression machine learning models, to determine a schedule overrun, a defect rate, and a sprint velocity for the change request. The method may include processing the vectorized data, with the classification machine learning model, to determine a story point for the change request, and calculating a resource capacity for the change request based on the vectorized data. The method may include generating an impact analysis based on one or more of the estimated effort, the user story, the IT requirements, the schedule overrun, the defect rate, the sprint velocity, the story point, or the resource capacity, and performing one or more actions based on the impact analysis.

Some implementations described herein relate to a device that includes one or more memories, and one or more processors coupled to the one or more memories. The one or more processors may receive a change request, work items associated with the change request, and IT data identifying IT deliverables, and normalize titles and descriptions, of the change requests, the work items, and the IT data, to generate processed data. The one or more processors may transform the processed data into vectorized data, and may select similarity analytics machine learning models, regression machine learning models, and a classification machine learning model based on the vectorized data. The one or more processors may process the vectorized data, with the similarity analytics machine learning models, to determine an estimated effort, a user story, and IT requirements for the change request, and may process the vectorized data, with the regression machine learning models, to determine a schedule overrun, a defect rate, and a sprint velocity for the change request. The one or more processors may process the vectorized data, with the classification machine learning model, to determine a story point for the change request, and may calculate a resource capacity for the change request based on the vectorized data. The one or more processors may generate an impact analysis based on one or more of the estimated effort, the user story, the IT requirements, the schedule overrun, the defect rate, the sprint velocity, the story point, or the resource capacity, and may perform one or more actions based on the impact analysis.

Some implementations described herein relate to a non-transitory computer-readable medium that stores a set of instructions for a device. The set of instructions, when executed by one or more processors of the device, may cause the device to receive a change request, work items associated with the change request, and IT data identifying IT deliverables, and process the change request, the work items, and the IT data to generate processed data. The set of instructions, when executed by one or more processors of the device, may cause the device to transform the processed data into vectorized data, and select similarity analytics machine learning models, regression machine learning models, and a classification machine learning model based on the vectorized data. The set of instructions, when executed by one or more processors of the device, may cause the device to process the vectorized data, with the similarity analytics machine learning models, to determine an estimated effort, a user story, and IT requirements for the change request, and process the vectorized data, with the regression machine learning models, to determine a schedule overrun, a defect rate, and a sprint velocity for the change request. The set of instructions, when executed by one or more processors of the device, may cause the device to process the vectorized data, with the classification machine learning model, to determine a story point for the change request, and calculate a resource capacity for the change request based on the vectorized data. The set of instructions, when executed by one or more processors of the device, may cause the device to generate an impact analysis based on one or more of the estimated effort, the user story, the IT requirements, the schedule overrun, the defect rate, the sprint velocity, the story point, or the resource capacity, and provide the impact analysis for display.

### BRIEF DESCRIPTION OF THE DRAWINGS

FIGS. 1A-1I are diagrams of an example implementation described herein.

FIG. 2 is a diagram illustrating an example of training and using a machine learning model.

FIG. 3 is a diagram of an example environment in which systems and/or methods described herein may be implemented.

FIG. 4 is a diagram of example components of one or more devices of FIG. 3.

FIG. 5 is a flowchart of an example process for utilizing machine learning models to analyze an impact of a change request.

### DETAILED DESCRIPTION

The following detailed description of example implementations refers to the accompanying drawings. The same reference numbers in different drawings may identify the same or similar elements.

Unanalyzed or poorly analyzed impacts of change requests for a product cause project teams to miss delivery timelines or to release ineffective or undesirable products and/or services. A change in objectives of an on-going project may even lead to project failure. Another common instance of project failure may occur during delivery and after delivery. Such a project failure may occur due to a project manager failing to preempt an impact that implementation and/or delivery has on the project team and failing to proactively manage changes, such as enhancements, revised scope, change requests, and/or the like. A change request for a project has to be analyzed, approved, and communicated, before the change request creates negative impacts that often cause missed commitments. Current techniques for analyzing change requests are based on experience of a project manager and/or on estimates produced by a development team, which are highly subjective. Furthermore, current techniques for analyzing change requests are time consuming and may require utilization of many disparate analysis systems.

Therefore, current techniques for analyzing change requests consume computing resources (e.g., processing resources, memory resources, communication resources, and/or the like), networking resources, and/or the like associated with utilizing disparate analysis systems and subjective experience to analyze impacts of change requests, determining incorrect impacts of change requests based on the subjective experience, delaying a project due to time wasted analyzing impacts of change requests, failing to meet project deadlines due to time wasted analyzing impacts of change requests, and/or the like.

Some implementations described herein relate to an analysis system that utilizes machine learning models to analyze an impact of a change request. For example, the analysis system may receive a change request, work items associated with the change request, and information technology (IT) data identifying IT deliverables, and may process the change request, the work items, and the IT data to generate processed data. The analysis system may transform the processed data into vectorized data, and may select similarity analytics machine learning models, regression machine learning models, and a classification machine learning model based on the vectorized data. The analysis system may process the vectorized data, with the similarity analytics machine learning models, to determine an estimated effort, a user story, and IT requirements for the change request, and may process the vectorized data, with the regression machine learning models, to determine a schedule overrun, a defect rate, and a sprint velocity for the change request. The analysis system may process the vectorized data, with the classification machine learning model, to determine a story point for the change request, and may calculate a resource capacity for the change request based on the vectorized data. The analysis system may generate an impact analysis based on one or more of the estimated effort, the user story, the IT requirements, the schedule overrun, the defect rate, the sprint velocity, the story point, or the resource capacity, and may perform one or more actions based on the impact analysis.

In this way, the analysis system utilizes machine learning models to analyze an impact of a change request. The analysis system may enable project managers to effectively analyze impacts of change requests based on multiple scenarios, and may enable the project managers to make informed decisions with respect to impacts of change requests on small-scale and large-scale project deliveries. The analysis system may provide analytics, predictions, and/or recommendations for a scope, a cost, a schedule, dependencies, a resource availability, a capability, a proficiency, a capacity, and/or the like associated with change requests. For example, the analysis system may indicate how a particular change request may alter a current state of a project and may recommend next steps for implementing the change request. If a release is in progress, the analysis system may utilize a current state of the release, an overrun at a point in time with respect to parameters (e.g., risks, issues, actions, open decisions, pending test cases for execution, execution completion percentage, etc.), and/or the like to calculate a feasibility of a change request. If the release is in an overrun status or near completion, the analysis system may not calculate the feasibility of the change request. The analysis system may complete the analysis of the impact of the change request within seconds (e.g., as opposed to hours, days, and/or the like), may generate a prediction of a next best feasible release based on the impact, and/or the like.

This, in turn, conserves computing resources, networking resources, and/or the like that would otherwise have been consumed in utilizing disparate analysis systems and subjective experience to analyze impacts of change requests, determining incorrect impacts of change requests based on the subjective experience, delaying a project due to time wasted analyzing impacts of change requests, failing to meet project deadlines due to time wasted analyzing impacts of change requests, and/or the like.

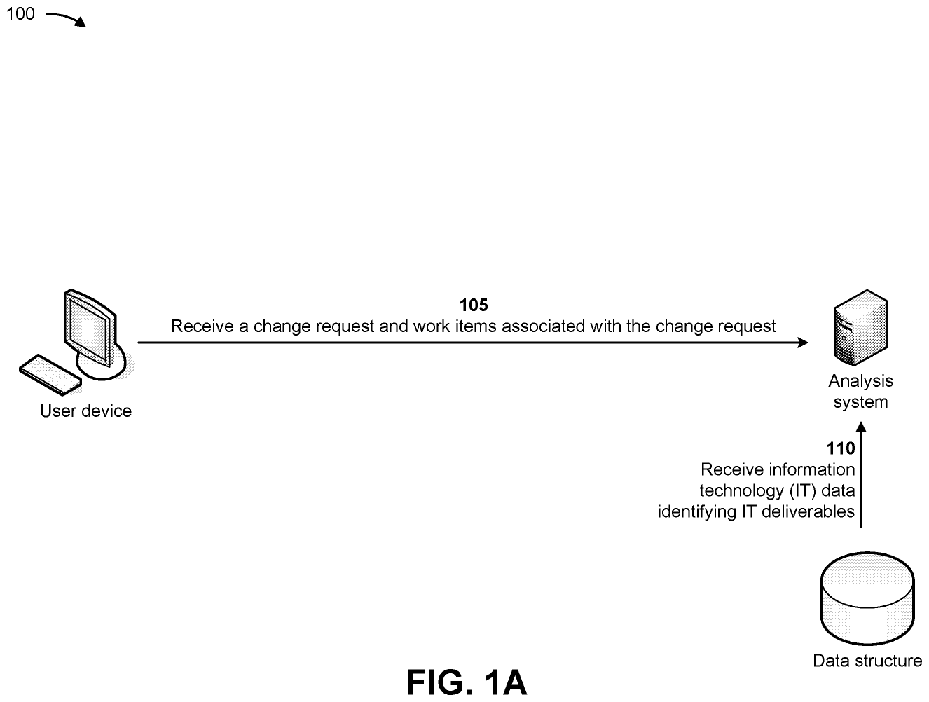

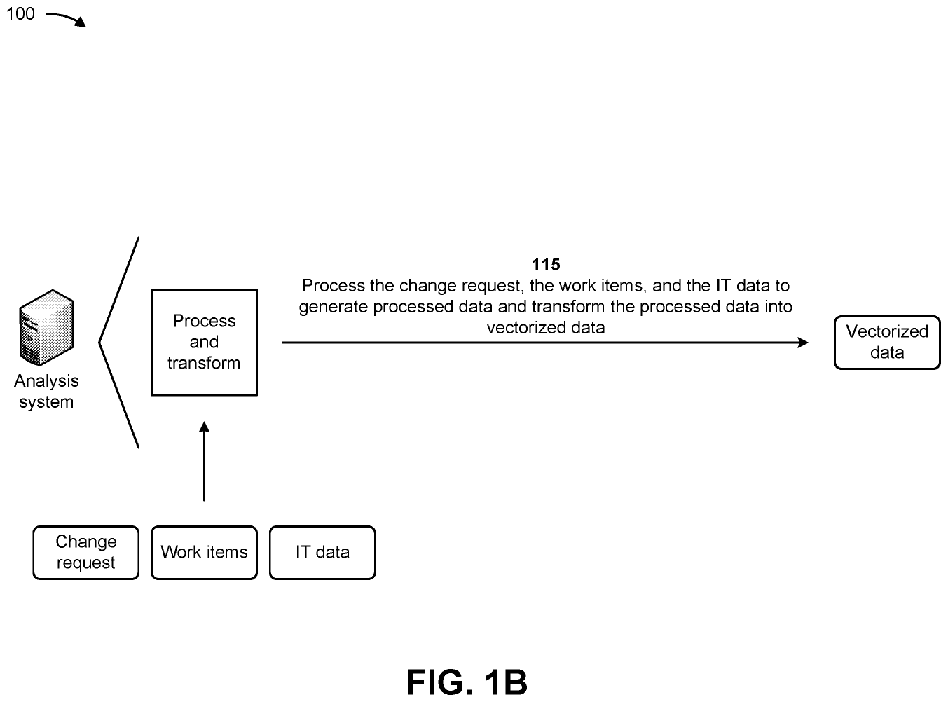

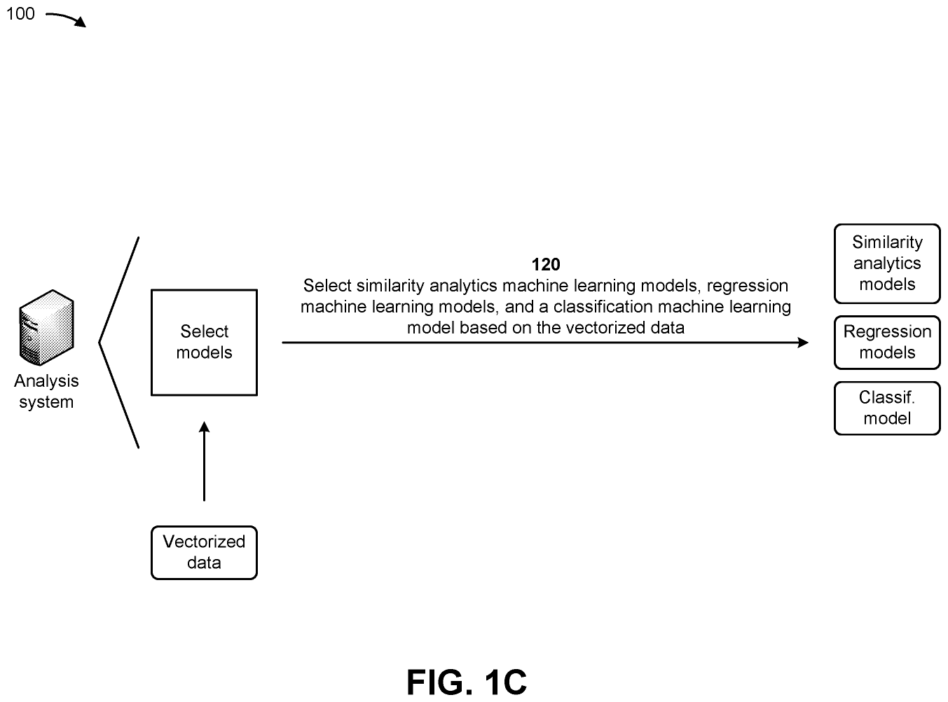

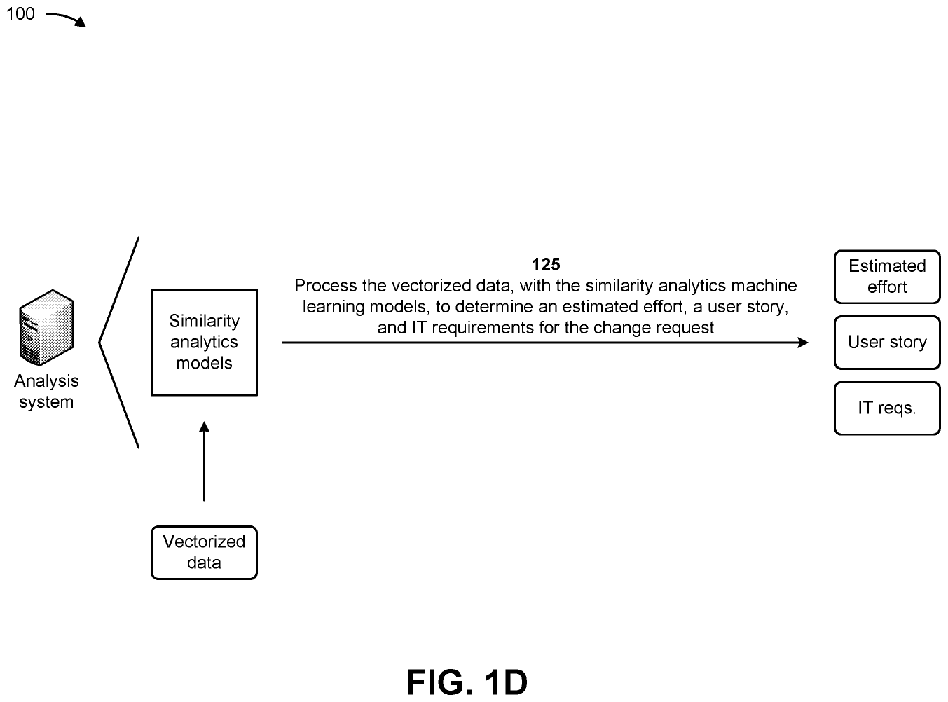

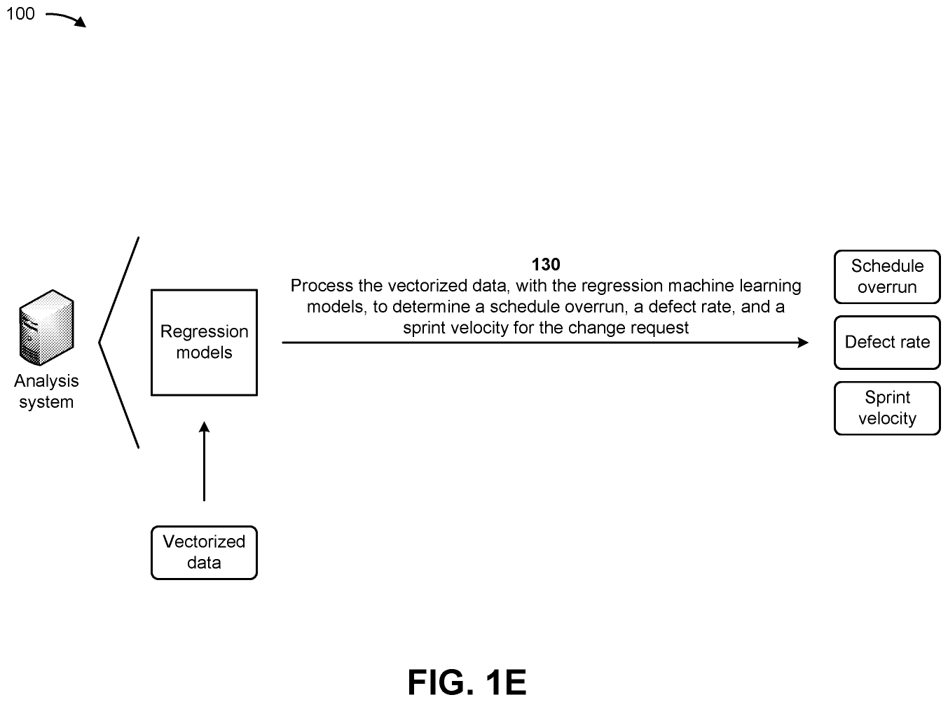

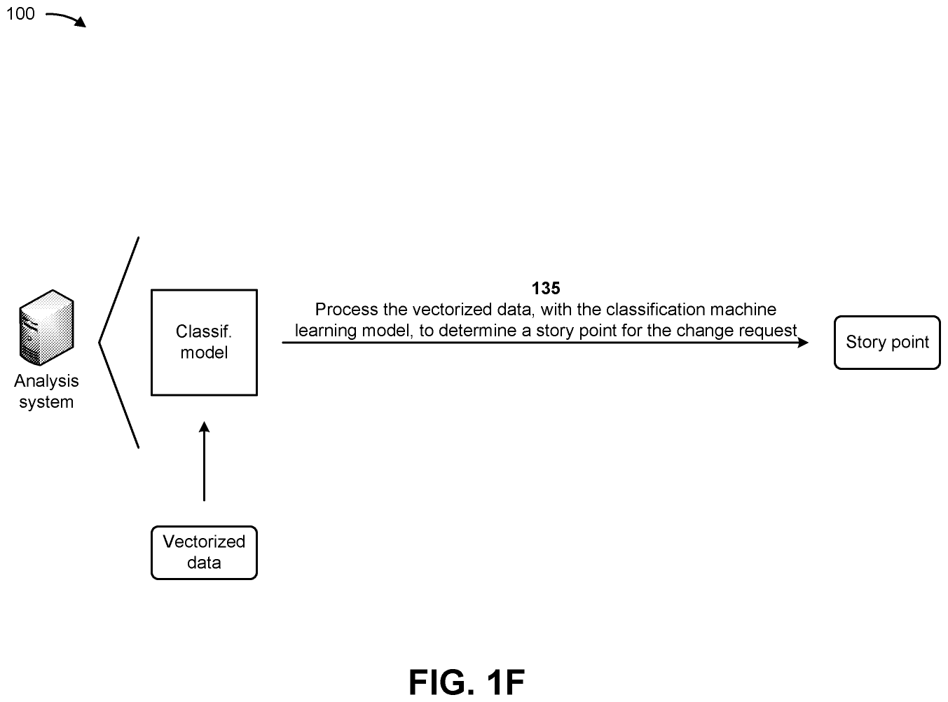

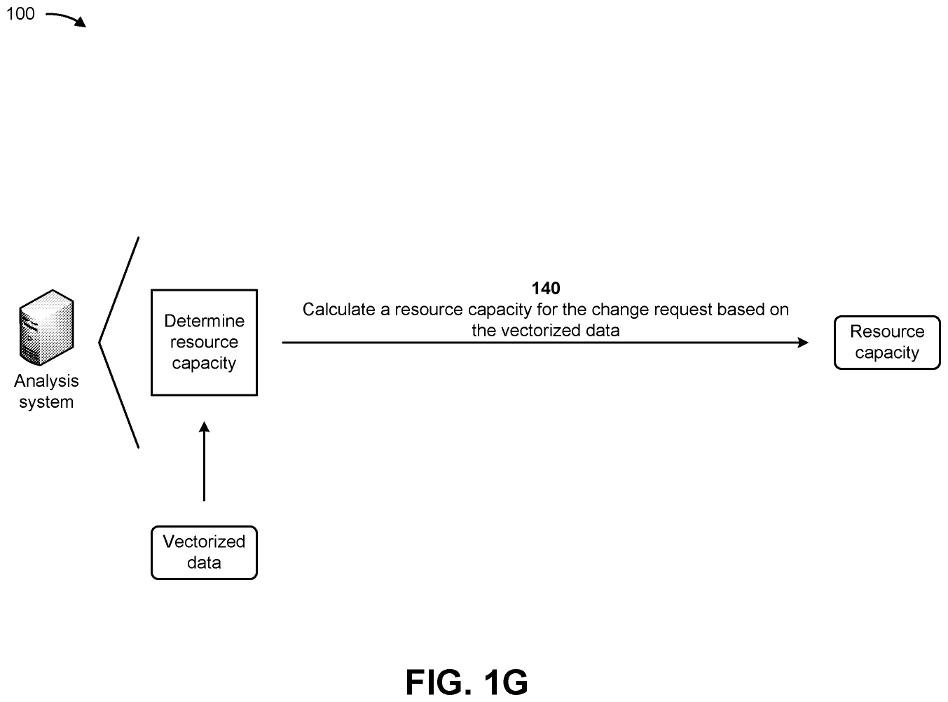

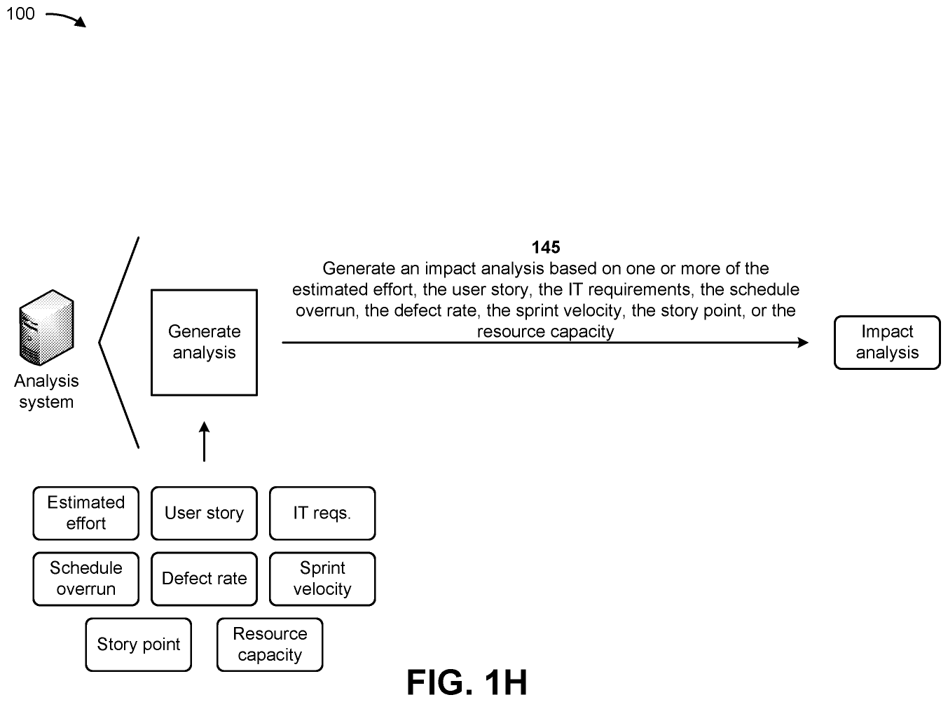

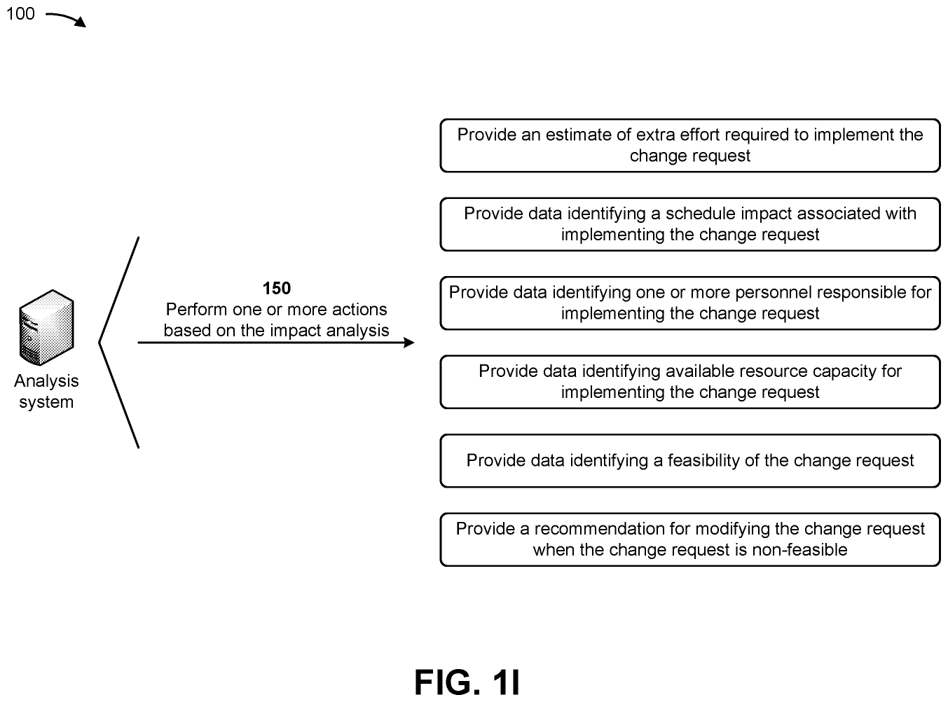

FIGS. 1A-1I are diagrams of an example 100 associated with utilizing machine learning models to analyze an impact of a change request. As shown in FIGS. 1A-1I, example 100 includes an analysis system associated with a user device and a data structure. The analysis system may include a system that utilizes machine learning models to analyze an impact of a change request. Further details of the analysis system, the user device, and the data structure are provided elsewhere herein.

As shown in FIG. 1A, and by reference number 105, the analysis system may receive a change request and work items associated with the change request. For example, a user may provide the change request and the work items associated with the change request to the user device and may cause the user device to provide the change request and the work items to the analysis system. The analysis system may receive the change request and the work items associated with the change request from the user device. In some implementations, the user device may automatically provide the change request and the work items to the analysis system when input by the user, may provide the change request and the work items to the analysis system based on an instruction from the user, and/or the like.

The change request may include a formal proposal for an alteration to some product and/or service (e.g., software, an application, and/or the like). In project management, a change request may occur when a customer of the product and/or service wants an addition or an alteration to agreed-upon deliverables for a project. Each of the work items may include a task to complete in order to cause the change request to occur. For example, in a scheduling software project, the change request may include request to provide a new feature (e.g., a new calendar) for the existing scheduling software. In such an example, a work item may include designing the new calendar, generating code to create the design for the new calendar, and/or the like.

As further shown in FIG. 1A, and by reference number 110, the analysis system may receive IT data identifying IT deliverables. For example, a data structure (e.g., a database, a table, a list, and/or the like) may be associated with the analysis system and may store the IT data. The analysis system may request the IT data from the data structure, and the data structure may provide the IT data to the analysis system based on the request. The analysis system may receive the IT data from the data structure. In some implementations, the data structure may periodically provide the IT data to the analysis system, may continuously provide the IT data to the analysis system, and/or the like. In such implementations, the analysis system may periodically receive the IT data from the data structure, may continuously receive the IT data from the data structure, and/or the like.

IT may include development, installation, and utilization of anything related to computing and telecommunications. Examples of IT include the creation of a new word processing program, cloud computing, alteration of an existing software program, and/or the like. The IT data may include numeric data, text data, audio data, image data, video data, and/or the like associated with an IT environment. In some implementations, the IT data may include data identifying user story titles, user story descriptions, statuses (e.g., accepted, rejected, or draft), requirements, and/or like associated with an IT environment, such as products and/or services provided by the IT environment.

As shown in FIG. 1B, and by reference number 115, the analysis system may process the change request, the work items, and the IT data to generate processed data and may transform the processed data into vectorized data. For example, when processing the change request, the work items, and the IT data to generate the processed data, the analysis system may normalize titles and descriptions of the change requests, the work items, and the IT data to generate the processed data. In some implementations, normalizing the titles and the descriptions of the change requests, the work items, and the IT data to generate the processed data may include the analysis system converting all letters, of the titles and the descriptions, to lower case or upper case, removing punctuations, accent marks, and other diacritics from the titles and the descriptions, removing white spaces from the titles and the descriptions, removing stop words from the titles and the descriptions, performing a stemming process on the titles and the descriptions, and/or the like. A stop word may include a commonly used word (e.g., the, a, an, in, and/or the like). The titles and the descriptions of the change requests, the work items, and the IT data may be normalized to save space in a data structure and improve performance of machine learning models described below. A stemming process may include a process that reduces words to a word stem, base, or root form. In some implementations, the analysis system may utilize a Porter stemming model to perform the stemming process.

In one example, the change request, the work items, and/or the IT data may include a first document that includes the text “the sky is blue” and a second document that includes the text “the sun is bright.” After processing these two documents, the analysis system may generate the following processed data (e.g., an indexed vocabulary, E(t) of terms t):

$$E ( t ) = \{ \begin{matrix}0 , if t is “ blue ” \\ 1 , if t is “ bright ” \\ 2 , if t is “ sky ” \\ 3 , if t is “ sun ”\end{matrix} .$$

In some implementations, the analysis system may transform the processed data into the vectorized data by converting text data, of the processed data, into vectors (e.g., which correspond to the vectorized data). For example, the analysis system may process the text data, with a term frequency-inverse document frequency (TF-IDF) model, to convert the text data into the vectors. In vectorization, the processed data (e.g., text documents) may be converted into numerical features or vectors to make the text documents more suitable for machine learning models. The analysis system may utilize the TF-IDF model for vectorization, over other vectorization models, due to ease of use and since the TF-IDF model indicates how relevant a term is in a given document. The TF-IDF model may balance out term frequency (e.g., how often a term appears in the document) with inverse document frequency (e.g., how often the term appears across all documents in the processed data).

Returning to the example of the two documents (e.g., a first document that includes the text “the sky is blue” and a second document that includes the text “the sun is bright”), the TF-IDF model may convert the two documents into a vector space, where each term of the vector is indexed as an index vocabulary. For example, a first term of the vector may be “blue,” a second term may be “sun,” and/or the like. The TF-IDF model may utilize term-frequency to measure how many times a term is present in the indexed vocabulary E(t). The term-frequency may be defined as counting function:

tƒ(t,d)=Σ_{x∈d}ƒr(x,t),

Where ƒr(x, t) is a simple function defined as:

$$fr ( x , t ) = \{ \begin{matrix}1 , & if x = t \\ 0 , & otherwise\end{matrix} .$$

In the above equation, the term-frequency tƒ(t, d) may return how many times a term t is present in a document d. For example, tƒ(sun, d₄) may be two (2).

In another example, two documents for which similarity is to be predicted may include a first document (d₃) with the text “the sun in the sky is bright” and a second document (d₄) with the text “we can see the shining sun, the bright sun.” The TF-IDF model may represent the two documents as vectors:

v_{\vec{d3}}=(tƒ(t₁,d₃),tƒ(t₂,d₃),tƒ(t₃,d₃), . . . ,tƒ(tₙ,d₃))

v_{\vec{d4}}=(tƒ(t₁,d₄),tƒ(t₂,d₄),tƒ(t₃,d₄), . . . ,tƒ(tₙ,d₄))

which evaluates to:

v_{\vec{d3}}=(0,1,1,1)

v_{\vec{d4}}=(0,1,0,2).

These term frequency vectors may be represented in a matrix form of tƒ(t, d) as [[0, 1, 1, 1], [0, 1, 0, 2]].

The TF-IDF model may calculate an inverse document frequency weight and may multiply the inverse document frequency weight with the above matrix to create TF-IDF vectors. The inverse document frequency may be defined as:

$$idf ( t ) = log \frac{\vert D \vert}{1 + \vert \{ d : t ∈ d \} \vert} ,$$

where |{d: t∈d}| is a quantity of documents where a term t appears. When a term-frequency function satisfies tƒ(t, d)=0, one is added into the formula to avoid dividing by zero. The inverse document frequency may be calculated for each term in a vocabulary against the two documents d₃ and d₄ to obtain an inverse document frequency matrix of a form [[2.09, 0, 0, 0], [0, 1, 0, 0], [0, 0, 1.4, 0], [0, 0, 0, 1]]. Multiplying the two matrices generates a vectorized form of the two documents d₃ and d₄ (e.g., the matrix form of tƒ(t, d)* the matrix form of idƒ(t)), as follows: V(d₃)=[0, 0.577, 0.5777, 0.5777] and V(d₄)=[0, 0.44, 0, 0.8999]. The vectorized form is much more sophisticated compared to simple models, such as a bag of words model, since the vectorized form places more emphasis on informative weightage of vocabulary words in a document. This may result in improved similarity analytics predictions, as described elsewhere herein.

In some implementations, the analysis system may process the vectorized data, with cosine similarity analytics, to identify a level of similarity between two documents. Cosine similarity may be calculated by the following formula:

$$cos ( V ( {d}_{3} ) , V ( {d}_{4} ) ) = \frac{V ( {d}_{3} ) * V ( {d}_{4} )}{( ‖ V ( {d}_{3} ) ‖ * ‖ V ( {d}_{4} ) ‖ )} .$$

Applying the values determined above (e.g., V(d₃)=[0, 0.577, 0.5777, 0.5777] and V(d₄)=[0, 0.44, 0, 0.8999]), results in a in 77.22% similarity between the two documents. The analysis system may apply a similarity threshold (e.g., 70%, 75%, and/or the like) to the calculated similarity when providing recommendations associated with the two documents.

As shown in FIG. 1C, and by reference number 120, the analysis system may select similarity analytics machine learning models, regression machine learning models, and a classification machine learning model based on the vectorized data. For example, the analysis system may replace the similar analytics described above with the selected similarity analytics machine learning models. In some implementations, when selecting the similarity analytics machine learning models based on the vectorized data, the analysis system may train a plurality of similarity analytics machine learning models with the vectorized data to generate results, and the analysis system may select the similarity analytics machine learning models from the plurality of similarity analytics machine learning models based on the results. For example, the analysis system may select the similarity analytics machine learning model(s) that generate the best results. The similarity analytics machine learning models may include one or more of a linear regression machine learning model, a logistic regression machine learning model, a ridge regressor machine learning model, a lasso regressor machine learning model, a gradient boost regressor machine learning model, a random forest regressor machine learning model, and/or the like.

In some implementations, when selecting the regression machine learning models based on the vectorized data, the analysis system may train a plurality of regression machine learning models, with the vectorized data, to generate results, and may select the regression machine learning models, from the plurality of regression machine learning models, based on the results. For example, the analysis system may select the regression machine learning models that generate the best results. The regression machine learning models may include one or more of a linear regression machine learning model, a logistic regression machine learning model, a ridge regressor machine learning model, a lasso regressor machine learning model, a gradient boost regressor machine learning model, a random forest regressor machine learning model, and/or the like.

In some implementations, when selecting the classification machine learning model based on the vectorized data, the analysis system may train a plurality of classification machine learning models with the vectorized data to generate results, and may select the classification machine learning model from the plurality of classification machine learning models based on the results. For example, the analysis system may select the classification machine learning model that generates the best results. The classification machine learning model may include one or more of an extreme gradient boosting classifier machine learning model combined with a logistic regression machine learning model (e.g., for categorical target variables), a support vector machine (SVM) learning model (e.g., for multilevel classification), random forest classifier machine learning model, and/or the like.

As shown in FIG. 1D, and by reference number 125, the analysis system may process the vectorized data, with the similarity analytics machine learning models, to determine an estimated effort, a user story, and IT requirements for the change request. For example, one or more of the similarity analytics machine learning models may determine the estimated effort for the change request (e.g., an effort required for the change request to be complete based on similar historical completed change requests) based on the vectorized data. The analysis system may replace the similarity analytics with the similarity analytics machine learning models based on influencers such as a title of the change request, a description of the change request, a business rationale of the change request, an estimated effort of the change request, a status of the change request, a change request type, a work item type, a priority of the change request, an impact of the change request, and/or the like. The enhanced similarity analytics machine learning models may predict change requests (e.g., similar to the change request) more holistically and may generate better recommendations.

In some implementations, one or more of the similarity analytics machine learning models may determine the user story and IT requirements for the change request based on the vectorized data. For example, the one or more of the similarity analytics machine learning models may identify similar user stories and IT requirements for the change request from the IT data (e.g., included in the vectorized data). The analysis system may generate similarity analytics that identify recommendations for the similar user stories and IT requirements, and may transform the similarity analytics into the similarity analytics machine learning models. The similarity analytics machine learning models may learn based on user actions, such as accepting or rejecting recommendations generated by the similarity analytics machine learning models. The analysis system may retrain the similarity analytics machine learning models with influencers, such as a user story title, a user story description, a recommended user story title, a recommended user story description, a confidence score, a status (e.g., accepted, rejected, or draft), and/or the like.

As shown in FIG. 1E, and by reference number 130, the analysis system may process the vectorized data, with the regression machine learning models, to determine a schedule overrun, a defect rate, and a sprint velocity for the change request. For example, the regression machine learning models may provide a type of predictive analytics that rely on a statistical approach to model a relationship between a dependent variable and a given set of independent variables. These regression machine learning models may predict change request performance parameters based on historical performance data (e.g., the IT data) and may provide predictions of the schedule overrun for the change request based on current performance influencers, the defect rate for the change request based on current performance, and the sprint velocity (e.g., an output delivery) for the change request. Each of the predictions may depend on different influencers. For example, the regression machine learning model that determines the schedule overrun for the change request may depend on influencers, such as an earned value (e.g., a sum of actual effort for planned requirements), a planned value (e.g., a sum of estimated effort for the planned requirements), actuals to date (e.g., a total effort spent on all tasks until a date in a release, including budgeted tasks, training time, and idle time), an end date variance (e.g., a difference between a planned end date and a latest estimated date), and/or the like.

The regression machine learning model that determines the defect rate for the change request may depend on influencers, such as an earned value (e.g., a sum of actual effort for planned requirements), a planned value (e.g., a sum of estimated effort for the planned requirements), a defect count (e.g., a quantity of defects injected in a release for the planned requirements), a test case count (e.g., a quantity of test cases planned for the release), a requirement count (e.g., a quantity of planned requirements for the release), and/or the like. The regression machine learning model that determines the sprint velocity for the change request may depend on influencers, such as a team identifier, a resource capacity for the team, planned user story points by the team for a closed sprint, planned tasks and defects for the team in the closed sprint, completed tasks and defects for the team in the closed sprint, defects assigned to user stories for the team, and/or the like.

Once the influencer data is gathered, the analysis system may clean the influencer data using a two-step process of data curation and transformation to ensure availability of quality data for all the influencers. The analysis system may overlay the regression machine learning models with the influencer data using a coefficient of determination. The analysis system may utilize a plurality of regression machine learning models and may select the regression machine learning models based on the coefficient of determination (e.g., the best fit regression machine learning models). In this way, the analysis system may cater to different types of data sets and counter any drawbacks associated with one or more of the regression machine learning models. The analysis system may periodically (e.g., every week, two weeks, and/or the like) train the plurality of regression machine learning models with the influencers, and may select the regression machine learning models based on the quality of the results. This may ensure closest approximations and improved accuracy with growing datasets.

As shown in FIG. 1F, and by reference number 135, the analysis system may process the vectorized data, with the classification machine learning model, to determine a story point for the change request. For example, the classification machine learning model may learn how to assign a class label to examples from the problem domain. The analysis system may utilize the classification machine learning model to determine the story point for the change request (e.g., close a user story). The analysis system may utilize a training dataset, with many examples of inputs and outputs from which to learn, to train the classification machine learning model. The classification machine learning model may process the training dataset and may calculate how to best map examples of input data to specific class labels. As such, the training dataset may be sufficiently representative of the problem and may include many examples of each class label. The class labels may include string values (e.g., spam, not spam, and/or the like), and the analysis system may map the class labels to numeric values before being provided to the classification machine learning model. This may be referred to as label encoding, where a unique integer is assigned to each class label (e.g., spam=0, no spam=1, and/or the like).

As shown in FIG. 1G, and by reference number 140, the analysis system may calculate a resource capacity for the change request based on the vectorized data. For example, the analysis system may calculate the resource capacity for a team (e.g., for implementing the change request) based on a capacity available for resources of the team between a start date and an end date associated with the change request. If the resource capacity for a team is not available, the analysis system may calculate the resource capacity by multiplying a quantity of resources in the team, a quantity of working days associated with the change request, and a quantity of working hours in a working day. In some implementations, the analysis system may utilize the story point for the change request to determine estimated story points. For example, the analysis system may divide the story point by a total resource capacity to determine a sprint productivity, and may multiply the sprint productivity and the resource capacity for the change request to determine the estimated story points. If the story point for the change request is not available, the analysis system may utilize historical data to determine the estimated story points.

As shown in FIG. 1H, and by reference number 145, the analysis system may generate an impact analysis based on one or more of the estimated effort, the user story, the IT requirements, the schedule overrun, the defect rate, the sprint velocity, the story point, or the resource capacity. For example, the analysis system may generate an impact analysis that includes data identifying one or more of the estimated effort, the user story, the IT requirements, the schedule overrun, the defect rate, the sprint velocity, the story point, or the resource capacity. In some implementations, the analysis system may generate a user interface that includes the data identifying one or more of the estimated effort, the user story, the IT requirements, the schedule overrun, the defect rate, the sprint velocity, the story point, or the resource capacity. The analysis system may provide the user interface to the user device, and the user device may display the user interface to the user.

The impact analysis may help project managers effectively analyze an impact of requested changes, considering a multitude of scenarios, and may help project managers make informed decisions with respect to changes and enhancements in project deliveries that could range from a small to even a large-scale deployment. The impact analysis may enable project managers to leverage features, such as analytics, predictions and recommendations, around scope, cost, schedule, dependencies, resource availability, capability, proficiency, capacity, and/or the like. The impact analysis may enable informed decision making when project dynamics are evolving and have a possible large-scale impact on stakeholders. Project managers, via the impact analysis, may be informed of all key parameters associated with a change request, which must be evaluated before deciding to implement the change request.

The impact analysis may remove subjective analysis, may evaluate cost versus benefits of a change request, and may display an effort required to close a change request based on similar closed change requests, and actual costs or efforts associated with the similar closed change request. The impact analysis may also include second level indirect associations which can have an impact on the change request (e.g., delayed user stories, risk, issues, decisions, and other dependencies). The impact analysis may include data identifying real-time capacity that is available for the change request based on historical output performance (e.g., measured through story points), a quality of deliverables (e.g., an effort required for fixing defects), planning for a team, team resource capacity availability for the change request, and/or the like.

The impact analysis may include a delivery plan with specific actionable points and recommendations for non-feasible changes. The actionable points may include assigning effort to high impact change requests, a sprint delivery plan for feasible changes or user stories, recommendations for accommodating non-feasible change requests by extending scope or by descoping low priority planned deliverables, and/or the like. The impact analysis may include an estimation of extra effort. For example, if a user selects one or multiple anticipated changes, the user may need to verify an estimated effort for the changes. To help the user in verifying the estimated effort, the impact analysis may include an actual effort spent on completion of similar changes or implementations in the past, an estimated story-point effort required for associated user stories and/or requirements, and/or the like. The impact analysis may include associations of changes and second-level dependencies, such as dependent or blocking user stories and/or requirements. The impact analysis may include an estimate of an end date for the change request and an extension to a project schedule based on the estimated end data. The impact analysis may include a recommendation of teams who may be responsible for implementation of the change request.

The impact analysis may include a delivery plan for the change request and/or one or more selected work items based a priority of a selected change request, user story, and/or requirements, dependencies of the selected change request, user story, and/or requirements, a capacity available of team resources, effort and schedule of the selected change request, user story, and/or requirements, a quality of deliverables, and/or the like. The impact analysis may include a list of feasible change requests categorized according to iterations in which the change requests can be accommodated. For change requests that are non-feasible, the impact analysis may include recommendations, such as descoping other work items and keeping an approved cost in check when the non-feasible change requests can replace work items, are already planned, have a low priority, fail to include dependencies, have not been initiated, and/or the like.

The impact analysis may include proactive prioritization to ensure that highest priority work items are delivered first. The impact analysis may prioritize user stories based on a weighted shortest job first framework, may rearrange the prioritized user story list based on dependencies, may include predicted teams for the user stories, may include an expected output from each of the predicted teams, may include a list of feasible user stories and iteration plans, and/or the like.

As shown in FIG. 1I, and by reference number 150, the analysis system may perform one or more actions based on the impact analysis. In some implementations, performing the one or more actions includes the analysis system providing an estimate of extra effort required to implement the change request. For example, the analysis system may process the vectorized data, with the similarity analytics machine learning models, to determine the estimate of the extra effort required to implement the change request. The analysis system may provide the estimate of the extra effort to the user device and the user device may provide the estimate of the extra effort for display to the user. In this way, the analysis system conserves computing resources, networking resources, transportation resources, and/or the like that would otherwise have been consumed in utilizing disparate analysis systems and subjective experience to analyze impacts of change requests.

In some implementations, performing the one or more actions includes the analysis system providing data identifying a schedule impact associated with implementing the change request. For example, the analysis system may process the vectorized data, with the regression machine learning models, to determine the schedule impact associated with implementing the change request. The analysis system may provide the data identifying the schedule impact to the user device, and the user device may provide the data identifying the schedule impact for display to the user. In this way, the analysis system conserves computing resources, networking resources, transportation resources, and/or the like that would otherwise have been consumed in determining incorrect impacts of change requests based on the subjective experience.

In some implementations, performing the one or more actions includes the analysis system providing data identifying one or more personnel responsible for implementing the change request. For example, the analysis system may identify a team (e.g., one or more personnel) responsible for implementing the change request. The analysis system may provide the data identifying the one or more personnel to the user device, and the user device may provide the data identifying the one or more personnel for display to the user. In this way, the analysis system conserves computing resources, networking resources, transportation resources, and/or the like that would otherwise have been consumed in delaying a project due to time wasted analyzing impacts of change requests.

In some implementations, performing the one or more actions includes the analysis system providing data identifying available resource capacity for implementing the change request. For example, the analysis system may calculate the available resource capacity for the change request based on the vectorized data. The analysis system may provide the data identifying the available resource capacity to the user device, and the user device may provide the data identifying the available resource capacity for display to the user. In this way, the analysis system conserves computing resources, networking resources, transportation resources, and/or the like that would otherwise have been consumed in failing to meet project deadlines due to time wasted analyzing impacts of change requests.

In some implementations, performing the one or more actions includes the analysis system providing data identifying a feasibility of the change request. For example, the analysis system may generate an impact analysis that includes a list of feasible change requests categorized according to iterations in which the change requests can be accommodated. The analysis system may provide the data identifying the feasibility of the change request to the user device, and the user device may provide the data identifying the feasibility of the change request for display to the user. In this way, the analysis system conserves computing resources, networking resources, transportation resources, and/or the like that would otherwise have been consumed in utilizing disparate analysis systems and subjective experience to analyze impacts of change requests.

In some implementations, performing the one or more actions includes the analysis system providing a recommendation for modifying the change request when the change request is non-feasible. For example, the analysis system may determine that the change request is non-feasible and may generate the recommendation for modifying the change request based on determining that the change request is non-feasible. The analysis system may provide the recommendation for modifying the change request to the user device, and the user device may provide recommendation for modifying the change request for display to the user. In this way, the analysis system conserves computing resources, networking resources, transportation resources, and/or the like that would otherwise have been consumed in determining incorrect impacts of change requests based on the subjective experience.

In this way, the analysis system utilizes machine learning models to analyze an impact of a change request. The analysis system may enable project managers to effectively analyze impacts of change requests based on multiple scenarios, and may enable the project managers to make informed decisions with respect to impacts of change requests on small-scale and large-scale project deliveries. The analysis system may provide analytics, predictions, and/or recommendations for a scope, a cost, a schedule, dependencies, a resource availability, a capability, a proficiency, a capacity, and/or the like associated with change requests. For example, the analysis system may indicate how a particular change request may alter a current state of a project and may recommend next steps for implementing the change request. This, in turn, conserves computing resources, networking resources, transportation resources, and/or the like that would otherwise have been consumed in utilizing disparate analysis systems and subjective experience to analyze impacts of change requests, determining incorrect impacts of change requests based on the subjective experience, delaying a project due to time wasted analyzing impacts of change requests, failing to meet project deadlines due to time wasted analyzing impacts of change requests, and/or the like.

As indicated above, FIGS. 1A-1I are provided as an example. Other examples may differ from what is described with regard to FIGS. 1A-1I. The number and arrangement of devices shown in FIGS. 1A-1I are provided as an example. In practice, there may be additional devices, fewer devices, different devices, or differently arranged devices than those shown in FIGS. 1A-1I. Furthermore, two or more devices shown in FIGS. 1A-1I may be implemented within a single device, or a single device shown in FIGS. 1A-1I may be implemented as multiple, distributed devices. Additionally, or alternatively, a set of devices (e.g., one or more devices) shown in FIGS. 1A-1I may perform one or more functions described as being performed by another set of devices shown in FIGS. 1A-1I.

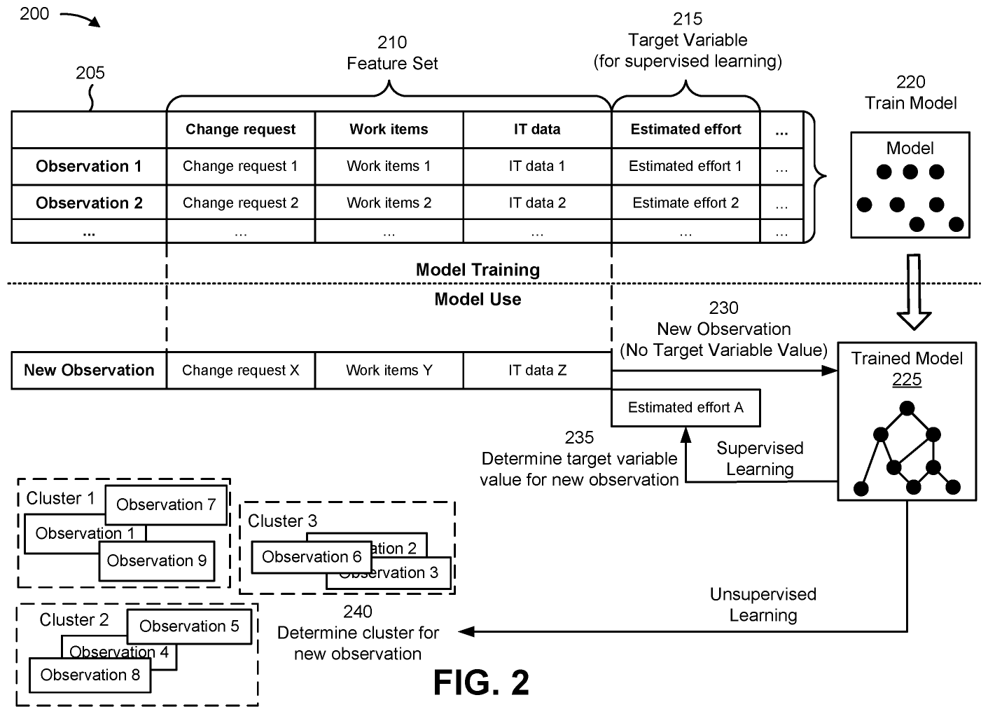

FIG. 2 is a diagram illustrating an example 200 of training and using a machine learning model for analyzing an impact of a change request. The machine learning model training and usage described herein may be performed using a machine learning system. The machine learning system may include or may be included in a computing device, a server, a cloud computing environment, and/or the like, such as the analysis system described in more detail elsewhere herein.

As shown by reference number 205, a machine learning model may be trained using a set of observations. The set of observations may be obtained from historical data, such as data gathered during one or more processes described herein. In some implementations, the machine learning system may receive the set of observations (e.g., as input) from the analysis system, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the analysis system. For example, the machine learning system may identify a feature set (e.g., one or more features and/or feature values) by extracting the feature set from structured data, by performing natural language processing to extract the feature set from unstructured data, by receiving input from an operator, and/or the like.

As an example, a feature set for a set of observations may include a first feature of a change request, a second feature of work items, a third feature of IT data, and so on. As shown, for a first observation, the first feature may have a value of change request 1, the second feature may have a value of work items 1, the third feature may have a value of IT data 1, and so on. These features and feature values are provided as examples and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, labels, and/or the like), may represent a variable having a Boolean value, and/or the like. A target variable may be associated with a target variable value, and a target variable value may be specific to an observation. In example 200, the target variable may be an estimate effort and may include a value of estimated effort 1 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, and/or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of change request X, a second feature of work items Y, a third feature of IT data Z, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs, information that indicates a degree of similarity between the new observation and one or more other observations, and/or the like, such as when unsupervised learning is employed.

As an example, the trained machine learning model 225 may predict a value of estimated effort A for the target variable of the estimated effort for the new observation, as shown by reference number 235. Based on this prediction, the machine learning system may provide a first recommendation, may provide output for determination of a first recommendation, may perform a first automated action, may cause a first automated action to be performed (e.g., by instructing another device to perform the automated action), and/or the like.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a change request cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., a work items cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification, categorization, and/or the like), may be based on whether a target variable value satisfies one or more thresholds (e.g., whether the target variable value is greater than a threshold, is less than a threshold, is equal to a threshold, falls within a range of threshold values, and/or the like), may be based on a cluster in which the new observation is classified, and/or the like.

In this way, the machine learning system may apply a rigorous and automated process to analyze an impact of a change request. The machine learning system enables recognition and/or identification of tens, hundreds, thousands, or millions of features and/or feature values for tens, hundreds, thousands, or millions of observations, thereby increasing accuracy and consistency and reducing delay associated with analyzing an impact of a change request relative to requiring computing resources to be allocated for tens, hundreds, or thousands of operators to manually analyze an impact of a change request.

As indicated above, FIG. 2 is provided as an example. Other examples may differ from what is described in connection with FIG. 2.

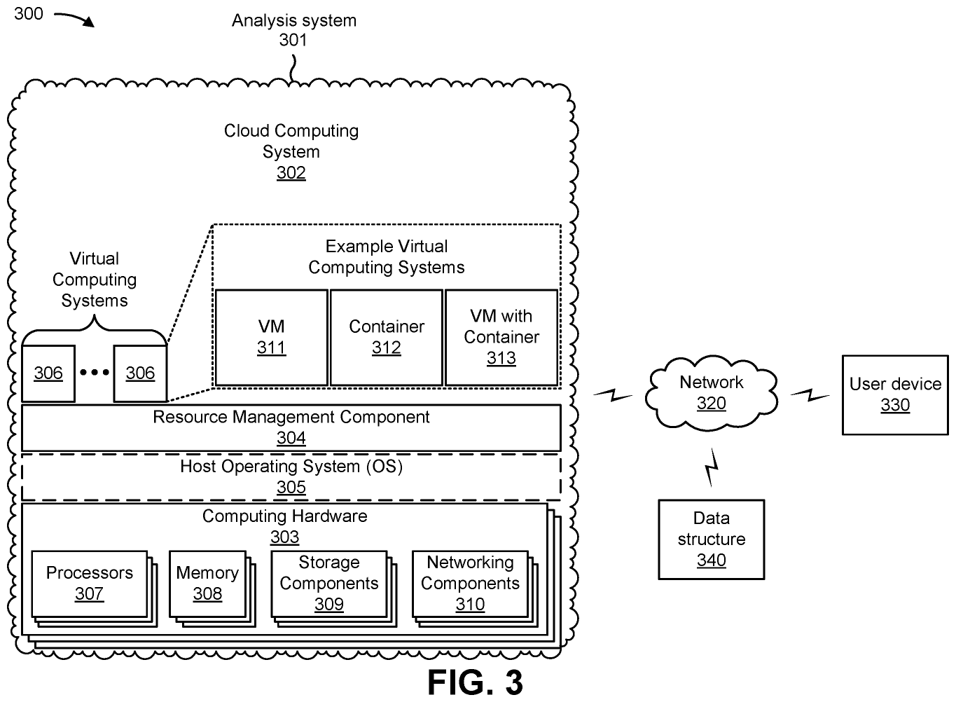

FIG. 3 is a diagram of an example environment 300 in which systems and/or methods described herein may be implemented. As shown in FIG. 3, the environment 300 may include an analysis system 301, which may include one or more elements of and/or may execute within a cloud computing system 302. The cloud computing system 302 may include one or more elements 303-313, as described in more detail below. As further shown in FIG. 3, the environment 300 may include a network 320, a user device 330, and/or a data structure 340. Devices and/or elements of the environment 300 may interconnect via wired connections and/or wireless connections.

The cloud computing system 302 includes computing hardware 303, a resource management component 304, a host operating system (OS) 305, and/or one or more virtual computing systems 306. The resource management component 304 may perform virtualization (e.g., abstraction) of the computing hardware 303 to create the one or more virtual computing systems 306. Using virtualization, the resource management component 304 enables a single computing device (e.g., a computer, a server, and/or the like) to operate like multiple computing devices, such as by creating multiple isolated virtual computing systems 306 from the computing hardware 303 of the single computing device. In this way, the computing hardware 303 can operate more efficiently, with lower power consumption, higher reliability, higher availability, higher utilization, greater flexibility, and lower cost than using separate computing devices.

The computing hardware 303 includes hardware and corresponding resources from one or more computing devices. For example, the computing hardware 303 may include hardware from a single computing device (e.g., a single server) or from multiple computing devices (e.g., multiple servers), such as multiple computing devices in one or more data centers. As shown, the computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as the computing hardware 303) capable of virtualizing the computing hardware 303 to start, stop, and/or manage the one or more virtual computing systems 306. For example, the resource management component 304 may include a hypervisor (e.g., a bare-metal or Type 1 hypervisor, a hosted or Type 2 hypervisor, and/or the like) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using computing hardware 303. As shown, a virtual computing system 306 may include a virtual machine 311, a container 312, a hybrid environment 313 that includes a virtual machine and a container, and/or the like. A virtual computing system 306 may execute one or more applications using a file system that includes binary files, software libraries, and/or other resources required to execute applications on a guest operating system (e.g., within the virtual computing system 306) or the host operating system 305.

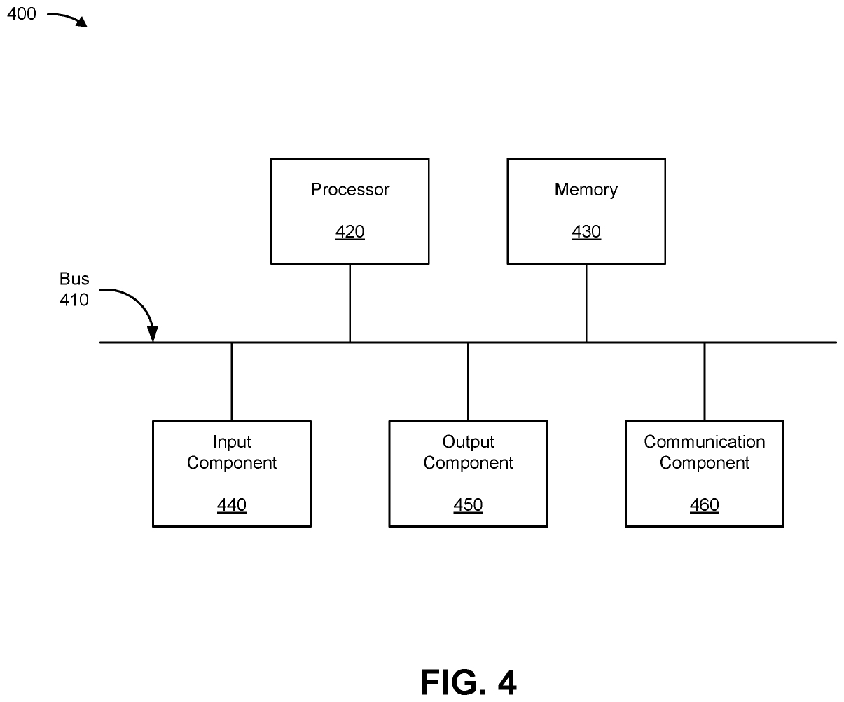

Although the analysis system 301 may include one or more elements 303-313 of the cloud computing system 302, may execute within the cloud computing system 302, and/or may be hosted within the cloud computing system 302, in some implementations, the analysis system 301 may not be cloud-based (e.g., may be implemented outside of a cloud computing system) or may be partially cloud-based. For example, the analysis system 301 may include one or more devices that are not part of the cloud computing system 302, such as device 400 of FIG. 4, which may include a standalone server or another type of computing device. The analysis system 301 may perform one or more operations and/or processes described in more detail elsewhere herein.

The network 320 includes one or more wired and/or wireless networks. For example, the network 320 may include a cellular network, a public land mobile network (PLMN), a local area network (LAN), a wide area network (WAN), a private network, the Internet, and/or the like, and/or a combination of these or other types of networks. The network 320 enables communication among the devices of the environment 300.

The user device 330 includes one or more devices capable of receiving, generating, storing, processing, and/or providing information, as described elsewhere herein. The user device 330 may include a communication device and/or a computing device. For example, the user device 330 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The data structure 340 includes one or more devices capable of receiving, generating, storing, processing, and/or providing information, as described elsewhere herein. The data structure 340 may include a communication device and/or a computing device. For example, the data structure 340 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data structure 340 may communicate with one or more other devices of the environment 300, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400, which may correspond to the analysis system 301 and/or the user device 330. In some implementations, the analysis system 301 and/or the user device 330 may include one or more devices 400 and/or one or more components of the device 400. As shown in FIG. 4, the device 400 may include a bus 410, a processor 420, a memory 430, an input component 440, an output component 450, and a communication component 460.

The bus 410 includes a component that enables wired and/or wireless communication among the components of device 400. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform a function. The memory 430 includes a random-access memory, a read only memory, and/or another type of memory (e.g., a flash memory, a magnetic memory, and/or an optical memory).

The input component 440 enables the device 400 to receive input, such as user input and/or sensed inputs. For example, the input component 440 may include a touch screen, a keyboard, a keypad, a mouse, a button, a microphone, a switch, a sensor, a global positioning system component, an accelerometer, a gyroscope, an actuator, and/or the like. The output component 450 enables the device 400 to provide output, such as via a display, a speaker, and/or one or more light-emitting diodes. The communication component 460 enables the device 400 to communicate with other devices, such as via a wired connection and/or a wireless connection. For example, the communication component 460 may include a receiver, a transmitter, a transceiver, a modem, a network interface card, an antenna, and/or the like.

The device 400 may perform one or more processes described herein. For example, a non-transitory computer-readable medium (e.g., the memory 430) may store a set of instructions (e.g., one or more instructions, code, software code, program code, and/or the like) for execution by the processor 420. The processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

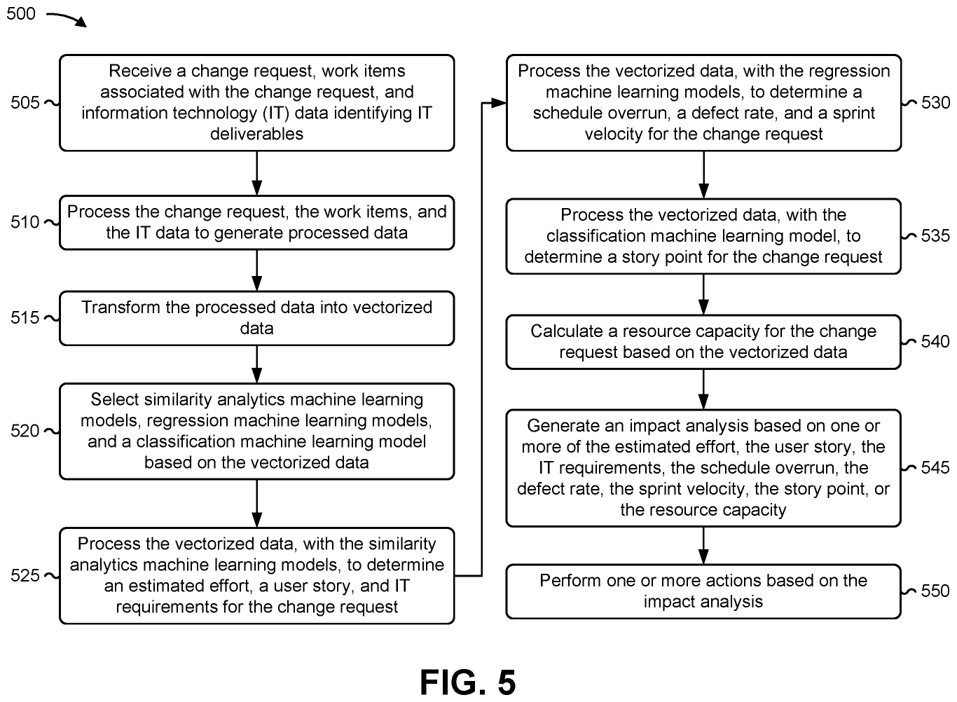

FIG. 5 is a flowchart of an example process 500 for utilizing machine learning models to analyze an impact of a change request. In some implementations, one or more process blocks of FIG. 5 may be performed by a device (e.g., the analysis system 301). In some implementations, one or more process blocks of FIG. 5 may be performed by another device or a group of devices separate from or including the device, such as a user device (e.g., the user device 330). Additionally, or alternatively, one or more process blocks of FIG. 5 may be performed by one or more components of the device 400, such as the processor 420, the memory 430, the input component 440, the output component 450, and/or the communication component 460.

As shown in FIG. 5, process 500 may include receiving a change request, work items associated with the change request, and IT data identifying IT deliverables (block 505). For example, the device may receive a change request, work items associated with the change request, and IT data identifying IT deliverables, as described above.

As further shown in FIG. 5, process 500 may include processing the change request, the work items, and the IT data to generate processed data (block 510). For example, the device may process the change request, the work items, and the IT data to generate processed data, as described above. In some implementations, processing the change request, the work items, and the IT data to generate the processed data includes normalizing titles and descriptions of the change requests, the work items, and the IT data to generate the processed data. In some implementations, normalizing the titles and the descriptions includes converting all letters, of the titles and the descriptions, to lower case or upper case; removing punctuations, accent marks, and other diacritics from the titles and the descriptions; removing white spaces from the titles and the descriptions; removing stop words from the titles and the descriptions; and performing a stemming process on the titles and the descriptions.

As further shown in FIG. 5, process 500 may include transforming the processed data into vectorized data (block 515). For example, the device may transform the processed data into vectorized data, as described above. In some implementations, transforming the processed data into the vectorized data includes converting text data, of the processed data, into vectors, wherein the vectors correspond to the vectorized data. In some implementations, converting the text data, of the processed data, into the vectors includes processing the text data, with a term frequency-inverse document frequency model, to convert the text data into the vectors.

As further shown in FIG. 5, process 500 may include selecting similarity analytics machine learning models, regression machine learning models, and a classification machine learning model based on the vectorized data (block 520). For example, the device may select similarity analytics machine learning models, regression machine learning models, and a classification machine learning model based on the vectorized data, as described above. In some implementations, selecting the similarity analytics machine learning models based on the vectorized data includes training a plurality of similarity analytics machine learning models, with the vectorized data, to generate results, and selecting the similarity analytics machine learning models, from the plurality of similarity analytics machine learning models, based on the results.

In some implementations, selecting the regression machine learning models based on the vectorized data includes training a plurality of regression machine learning models, with the vectorized data, to generate results, and selecting the regression machine learning models, from the plurality of regression machine learning models, based on the results. In some implementations, selecting the classification machine learning model based on the vectorized data includes training a plurality of classification machine learning models, with the vectorized data, to generate results, and selecting the classification machine learning model, from the plurality of classification machine learning models, based on the results.

In some implementations, the regression machine learning models include one or more of a linear regression machine learning model, a logistic regression machine learning model, a ridge regressor machine learning model, a lasso regressor machine learning model, a gradient boost regressor machine learning model, or a random forest regressor machine learning model. In some implementations, the similarity analytics machine learning models include one or more of a linear regression machine learning model, a logistic regression machine learning model, a ridge regressor machine learning model, a lasso regressor machine learning model, a gradient boost regressor machine learning model, or a random forest regressor machine learning model.

As further shown in FIG. 5, process 500 may include processing the vectorized data, with the similarity analytics machine learning models, to determine an estimated effort, a user story, and IT requirements for the change request (block 525). For example, the device may process the vectorized data, with the similarity analytics machine learning models, to determine an estimated effort, a user story, and IT requirements for the change request, as described above.

As further shown in FIG. 5, process 500 may include processing the vectorized data, with the regression machine learning models, to determine a schedule overrun, a defect rate, and a sprint velocity for the change request (block 530). For example, the device may process the vectorized data, with the regression machine learning models, to determine a schedule overrun, a defect rate, and a sprint velocity for the change request, as described above.

As further shown in FIG. 5, process 500 may include processing the vectorized data, with the classification machine learning model, to determine a story point for the change request (block 535). For example, the device may process the vectorized data, with the classification machine learning model, to determine a story point for the change request, as described above.

As further shown in FIG. 5, process 500 may include calculating a resource capacity for the change request based on the vectorized data (block 540). For example, the device may calculate a resource capacity for the change request based on the vectorized data, as described above.

As further shown in FIG. 5, process 500 may include generating an impact analysis based on one or more of the estimated effort, the user story, the IT requirements, the schedule overrun, the defect rate, the sprint velocity, the story point, or the resource capacity (block 545). For example, the device may generate an impact analysis based on one or more of the estimated effort, the user story, the IT requirements, the schedule overrun, the defect rate, the sprint velocity, the story point, or the resource capacity, as described above.

As further shown in FIG. 5, process 500 may include performing one or more actions based on the impact analysis (block 550). For example, the device may perform one or more actions based on the impact analysis, as described above. In some implementations, performing the one or more actions includes one or more of providing, for display, an estimate of extra effort required to implement the change request, providing, for display, data identifying a schedule impact associated with implementing the change request, or providing, for display, data identifying one or more personnel responsible for implementing the change request. In some implementations, performing the one or more actions includes one or more of providing, for display, data identifying available resource capacity for implementing the change request, providing, for display, data identifying a feasibility of the change request, or providing, for display, a recommendation for modifying the change request when the change request is non-feasible. In some implementations, performing the one or more actions includes providing the impact analysis for display, receiving a modification to the change request based on providing the impact analysis for display, and generating a new impact analysis based on the modification to the change request.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description but is not intended to be exhaustive or to limit the implementations to the precise form disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, and/or the like, depending on the context.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, a change request, work items associated with the change request, and information technology (IT) data identifying IT deliverables;
processing, by the device, the change request, the work items, and the IT data to generate processed data;
transforming, by the device, the processed data into vectorized data;
selecting, by the device, similarity analytics machine learning models, regression machine learning models, and a classification machine learning model based on the vectorized data;
processing, by the device, the vectorized data, with the similarity analytics machine learning models, to determine an estimated effort, a user story, and IT requirements for the change request;
processing, by the device, the vectorized data, with the regression machine learning models, to determine a schedule overrun, a defect rate, and a sprint velocity for the change request;
processing, by the device, the vectorized data, with the classification machine learning model, to determine a story point for the change request;
calculating, by the device, a resource capacity for the change request based on the vectorized data;
generating, by the device, an impact analysis based on one or more of the estimated effort, the user story, the IT requirements, the schedule overrun, the defect rate, the sprint velocity, the story point, or the resource capacity; and
performing, by the device, one or more actions based on the impact analysis.

2. The method of claim 1, wherein processing the change request, the work items, and the IT data to generate the processed data comprises:
normalizing titles and descriptions of the change request, the work items, and the IT data to generate the processed data.

3. The method of claim 2, wherein normalizing the titles and the descriptions comprises:
converting all letters, of the titles and the descriptions, to lower case or upper case;
removing punctuations, accent marks, and other diacritics from the titles and the descriptions;
removing white spaces from the titles and the descriptions;
removing stop words from the titles and the descriptions; and
performing a stemming process on the titles and the descriptions.

4. The method of claim 1, wherein transforming the processed data into the vectorized data comprises:
converting text data, of the processed data, into vectors,
wherein the vectors correspond to the vectorized data.

5. The method of claim 4, wherein converting the text data, of the processed data, into the vectors comprises:
processing the text data, with a term frequency-inverse document frequency model, to convert the text data into the vectors.

6. The method of claim 1, wherein selecting the similarity analytics machine learning models based on the vectorized data comprises:
training a plurality of similarity analytics machine learning models, with the vectorized data, to generate results; and
selecting the similarity analytics machine learning models, from the plurality of similarity analytics machine learning models, based on the results.

7. The method of claim 1, wherein selecting the regression machine learning models based on the vectorized data comprises:
training a plurality of regression machine learning models, with the vectorized data, to generate results; and
selecting the regression machine learning models, from the plurality of regression machine learning models, based on the results.

8. A device, comprising:
one or more memories; and
one or more processors, coupled to the one or more memories, configured to:
receive a change request, work items associated with the change request, and information technology (IT) data identifying IT deliverables;
normalize titles and descriptions, of the change request, the work items, and the IT data, to generate processed data;
transform the processed data into vectorized data;
select similarity analytics machine learning models, regression machine learning models, and a classification machine learning model based on the vectorized data;
process the vectorized data, with the similarity analytics machine learning models, to determine an estimated effort, a user story, and IT requirements for the change request;
process the vectorized data, with the regression machine learning models, to determine a schedule overrun, a defect rate, and a sprint velocity for the change request;
process the vectorized data, with the classification machine learning model, to determine a story point for the change request;
calculate a resource capacity for the change request based on the vectorized data;
generate an impact analysis based on one or more of the estimated effort, the user story, the IT requirements, the schedule overrun, the defect rate, the sprint velocity, the story point, or the resource capacity; and
perform one or more actions based on the impact analysis.

9. The device of claim 8, wherein the one or more processors, to select the classification machine learning model based on the vectorized data, are configured to:
train a plurality of classification machine learning models, with the vectorized data, to generate results; and
select the classification machine learning model, from the plurality of classification machine learning models, based on the results.

10. The device of claim 8, wherein the regression machine learning models include one or more of:
a linear regression machine learning model,
a logistic regression machine learning model,
a ridge regressor machine learning model,
a lasso regressor machine learning model,
a gradient boost regressor machine learning model, or
a random forest regressor machine learning model.

11. The device of claim 8, wherein the similarity analytics machine learning models include one or more of:
a linear regression machine learning model,
a logistic regression machine learning model,
a ridge regressor machine learning model,
a lasso regressor machine learning model,
a gradient boost regressor machine learning model, or
a random forest regressor machine learning model.

12. The device of claim 8, wherein the one or more processors, to perform the one or more actions, are configured to one or more of:
provide, for display, an estimate of extra effort required to implement the change request;
provide, for display, data identifying a schedule impact associated with implementing the change request; or
provide, for display, data identifying one or more personnel responsible for implementing the change request.

13. The device of claim 8, wherein the one or more processors, to perform the one or more actions, are configured to one or more of:
provide, for display, data identifying available resource capacity for implementing the change request;
provide, for display, data identifying a feasibility of the change request; or
provide, for display, a recommendation for modifying the change request when the change request is non-feasible.

14. The device of claim 8, wherein the one or more processors, to perform the one or more actions, are configured to:
provide the impact analysis for display;
receive a modification to the change request based on providing the impact analysis for display; and
generate a new impact analysis based on the modification to the change request.

15. A non-transitory computer-readable medium storing a set of instructions, the set of instructions comprising:
one or more instructions that, when executed by one or more processors of a device, cause the device to:
receive a change request, work items associated with the change request, and information technology (IT) data identifying IT deliverables;
process the change request, the work items, and the IT data to generate processed data;
transform the processed data into vectorized data;
select similarity analytics machine learning models, regression machine learning models, and a classification machine learning model based on the vectorized data;
process the vectorized data, with the similarity analytics machine learning models, to determine an estimated effort, a user story, and IT requirements for the change request;
process the vectorized data, with the regression machine learning models, to determine a schedule overrun, a defect rate, and a sprint velocity for the change request;
process the vectorized data, with the classification machine learning model, to determine a story point for the change request;
calculate a resource capacity for the change request based on the vectorized data;
generate an impact analysis based on one or more of the estimated effort, the user story, the IT requirements, the schedule overrun, the defect rate, the sprint velocity, the story point, or the resource capacity; and
provide the impact analysis for display.

16. The non-transitory computer-readable medium of claim 15, wherein the one or more instructions, that cause the device to process the change request, the work items, and the IT data to generate the processed data, cause the device to:
convert all letters, of titles and descriptions of the change request, the work items, and the IT data, to lower case or upper case;
remove punctuations, accent marks, and other diacritics from the titles and the descriptions;
remove white spaces from the titles and the descriptions;
remove stop words from the titles and the descriptions; and
perform a stemming process on the titles and the descriptions.

17. The non-transitory computer-readable medium of claim 15, wherein the one or more instructions, that cause the device to transform the processed data into the vectorized data, cause the device to:
process text data of the processed data, with a term frequency-inverse document frequency model, to convert the text data into vectors,
wherein the vectors correspond to the vectorized data.

18. The non-transitory computer-readable medium of claim 15, wherein the one or more instructions, that cause the device to select the similarity analytics machine learning models based on the vectorized data, cause the device to:
train a plurality of similarity analytics machine learning models, with the vectorized data, to generate results; and
select the similarity analytics machine learning models, from the plurality of similarity analytics machine learning models, based on the results.

19. The non-transitory computer-readable medium of claim 15, wherein the one or more instructions, that cause the device to select the regression machine learning models based on the vectorized data, cause the device to:
train a plurality of regression machine learning models, with the vectorized data, to generate results; and
select the regression machine learning models, from the plurality of regression machine learning models, based on the results.

20. The non-transitory computer-readable medium of claim 15, wherein the one or more instructions, that cause the device to select the classification machine learning model based on the vectorized data, cause the device to:
train a plurality of classification machine learning models, with the vectorized data, to generate results; and
select the classification machine learning model, from the plurality of classification machine learning models, based on the results.
